(19) United States
(12) Patent Application Publication
(10) Pub. No.: US 2023/0141020 A1
(43) Pub. Date: May 11, 2023

(54) MAXIMUM PERMISSIBLE EXPOSURE ASSISTANCE INFORMATION REPORT

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 17/904,242

(22) PCT Filed: Mar. 6, 2020
(86) PCT No.: PCT/CN2020/078115

§ 371 Date: Aug. 15, 2022

(51) Int. Cl. H04W 52/24; H04W 72/1268; H04W 52/42

(52) U.S. Cl. CPC H04W 52/245; H04W 72/1268; H04W 52/42

(57) ABSTRACT

Aspects of the present disclosure relate to wireless communications, and more particularly, to techniques for handling maximum permissible exposure (MPE) events. In some cases, upon detecting an MPE event, a UE may provide assistance information that a base station may use to adjust uplink scheduling in an effort to reduce impact of the MPE event.

### FIELD OF THE DISCLOSURE

Aspects of the present disclosure relate to wireless communications, and more particularly, to techniques for handling maximum permissible exposure (MPE) events.

### DESCRIPTION OF RELATED ART

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects provide a method for wireless communication by a user equipment. The method generally includes detecting a potential maximum permissible exposure (MPE) event and providing MPE assistance information to a network entity in response to the detection.

Certain aspects provide a method for wireless communication by a network entity. The method generally includes receiving, from a user equipment (UE), maximum permissible exposure (MPE) assistance information indicating the UE has detected an MPE event and using the MPE assistance information to adjust uplink scheduling of the UE in an effort to reduce impact of the MPE event.

Certain aspects provide means for, apparatus, and/or computer readable medium having computer executable code stored thereon, for performing the techniques described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example base station (BS) and user equipment (UE), in accordance with certain aspects of the present disclosure.

FIGS. 3A-3C illustrate example MPE events.

FIGS. 4A-4B illustrate example MPE events in carrier aggregation (CA) scenarios.

FIG. 5 illustrates example operations that may be performed by a user equipment (UE), in accordance with certain aspects of the present disclosure.

FIG. 6 illustrates example operations that may be performed by a network entity, in accordance with certain aspects of the present disclosure.

FIG. 7 illustrates an example MPE assistance configuration, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to techniques for handling maximum permissible exposure (MPE) events.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

### Example Wireless Communications System

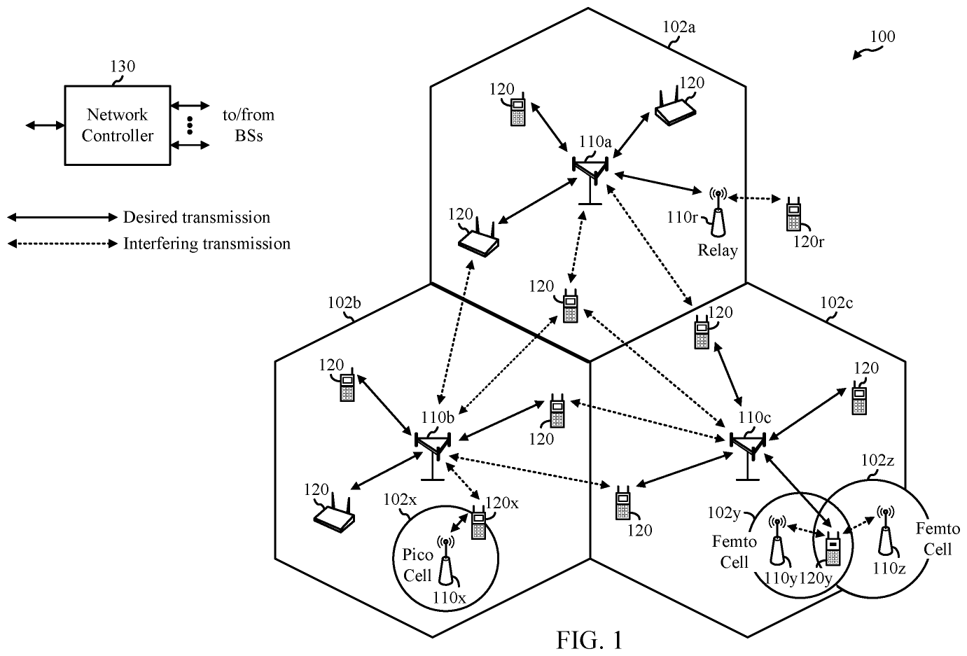

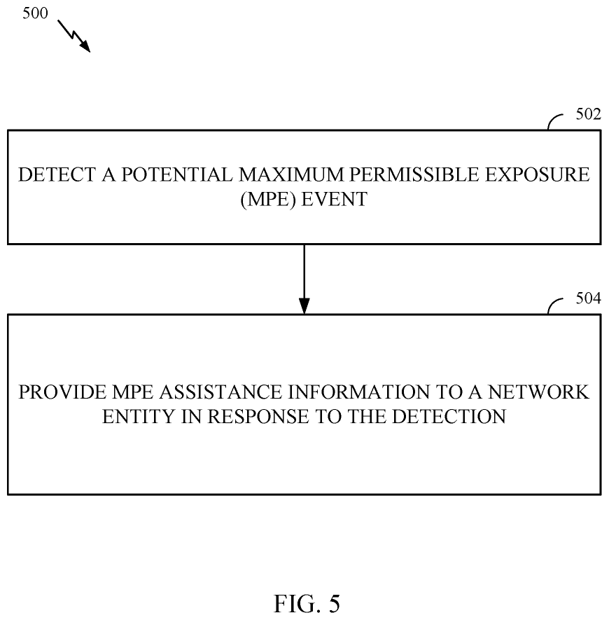

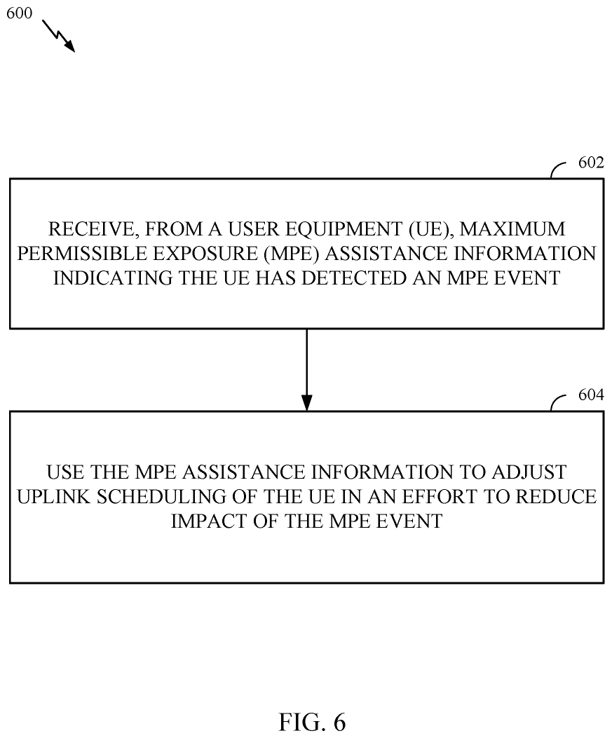

FIG. 1 illustrates an example wireless communication network 100 in which aspects of the present disclosure may be performed. For example, UEs 120 and BS 110 of FIG. 1 may be configured to perform operations described below with reference to FIGS. 5 and 6, respectively, to handle MPE events.

As illustrated in FIG. 1, the wireless communication network 100 may include a number of base stations (BSs) 110 and other network entities. A BS may be a station that communicates with user equipments (UEs). Each BS 110 may provide communication coverage for a particular geographic area. In 3GPP, the term “cell” can refer to a coverage area of a Node B (NB) and/or a NB subsystem serving this coverage area, depending on the context in which the term is used. In NR systems, the term “cell” and next generation NodeB (gNB or gNodeB), NR BS, 5G NB, access point (AP), or transmission reception point (TRP) may be interchangeable. In some examples, a cell may not necessarily be stationary, and the geographic area of the cell may move according to the location of a mobile BS. In some examples, the base stations may be interconnected to one another and/or to one or more other base stations or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless communication network 100 may be a heterogeneous network that includes BSs of different types, e.g., macro BS, pico BS, femto BS, relays, etc. These different types of BSs may have different transmit power levels, different coverage areas, and different impact on interference in the wireless communication network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

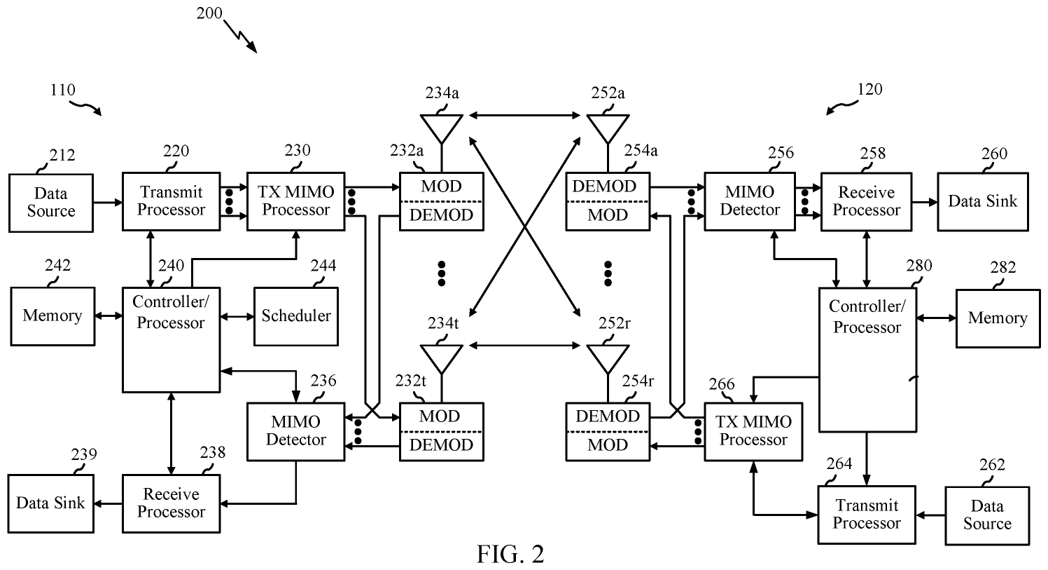

FIG. 2 shows a block diagram illustrating an example base station (BS) and an example user equipment (UE) in accordance with some aspects of the present disclosure.

At the BS 110, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (for example, encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MIMO) processor 230 may perform spatial processing (for example, precoding) on the data symbols, the control symbols, or the reference symbols, if applicable, and may provide output symbol streams to the modulators (MODs) 232a-232t. Each modulator 232 may process a respective output symbol stream (for example, for OFDM, etc.) to obtain an output sample stream. Each modulator may further process (for example, convert to analog, amplify, filter, and upconvert) the output sample stream to obtain a downlink signal. Downlink signals from modulators 232a-232t may be transmitted via the antennas 234a-234t, respectively.

At the UE 120, the antennas 252a-252r may receive the downlink signals from the BS 110 and may provide received signals to the demodulators (DEMODs) in transceivers 254a-254r, respectively. Each demodulator 254 may condition (for example, filter, amplify, downconvert, and digitize) a respective received signal to obtain input samples. Each demodulator may further process the input samples (for example, for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (for example, demodulate, deinterleave, and decode) the detected symbols, provide decoded data for the UE 120 to a data sink 260, and provide decoded control information to a controller/processor 280.

On the uplink, at UE 120, a transmit processor 264 may receive and process data (for example, for the physical uplink shared channel (PUSCH)) from a data source 262 and control information (for example, for the physical uplink control channel (PUCCH) from the controller/processor 280. The transmit processor 264 may also generate reference symbols for a reference signal (for example, for the sounding reference signal (SRS)). The symbols from the transmit processor 264 may be precoded by a TX MIMO processor 266 if applicable, further processed by the demodulators in transceivers 254a-254r (for example, for SC-FDM, etc.), and transmitted to the BS 110. At the BS 110, the uplink signals from the UE 120 may be received by the antennas 234, processed by the modulators 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

The memories 242 and 282 may store data and program codes for BS 110 and UE 120, respectively. A scheduler 244 may schedule UEs for data transmission on the downlink or uplink.

The controller/processor 280 (and/or other processors and modules) at the UE 120 and/or the controller/processor 240 (and/or other processors and modules) of the BS 110 may direct perform or direct the execution of processes for the techniques described herein (e.g., with reference to FIGS. 5 and 6).

### Example MPE Assistance Information Report

Aspects of the present disclosure relate to wireless communications, and more particularly, to techniques for handling maximum permissible exposure (MPE) events. As will be described below, a UE may be configured to report MPE assistance information upon detecting an MPE event. The MPE assistance information may allow a gNB to adjust uplink scheduling in an effort to reduce the impact of the MPE event detected by the UE.

Upon detecting a signal path being at least partially blocked, for example, by a user hand, a UE may be configured to switch antenna panels and/or increase the transmit power to compensate for the higher path loss caused by the blockage. However, transmissions in the mmWave frequencies may have potential health impacts to human bodies. Thus, certain regulatory organizations, such as Federal Communications Commission (FCC) and International Commission on Non-Ionizing Radiation Protection (ICNIRP), impose maximum permissible exposure (MPE) constraints on transmitters at various carrier frequencies. MPE constraints are typically specified in terms of short-term temporal averaging of radiated power, medium-term temporal averaging of radiated power, local-spatial averaging of radiated power, and/or medium-spatial averaging of radiated power. Thus, while a UE may increase the transmission power at a blocked antenna or panel, the UE may be required to conform to MPE constraints imposed by regulatory organizations. As such, a UE may not be able to increase the transmission power by a sufficient amount to overcome the high path loss caused by the user's hand.

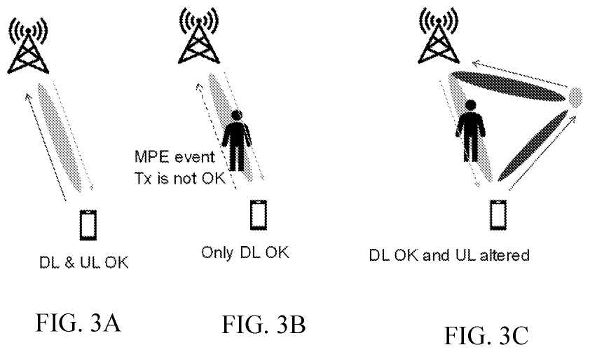

FIG. 3A illustrates an example scenario before an MPE event, where downlink and uplink transmissions are not impacted. In other words, in FIG. 3A, uplink transmissions from the UE may not exceed MPE constraints, so no MPE event is detected. In FIG. 3B, downlink transmissions still comply with MPE constraints, however because of a blocked signal path, in order to successfully transmit on the uplink the UE may need to use transmission parameters that do not comply with one or more MPE constraints. Therefore, in FIG. 3B, an MPE event is detected for uplink transmissions. In FIG. 3C, uplink transmission parameters have been modified so that no MPE event is detected.

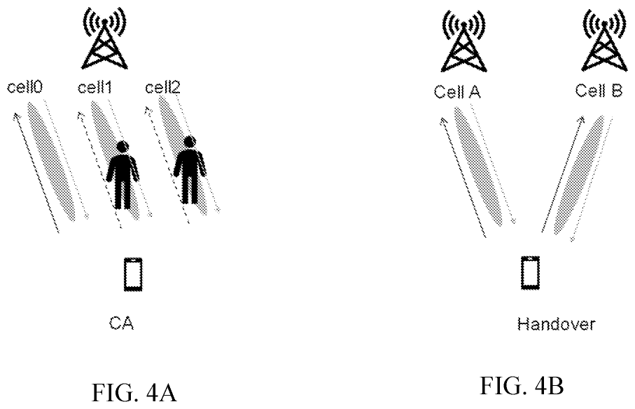

In some cases, the modification of uplink transmission parameters may be based on MPE assistance information, as described herein. While the examples shown in FIGS. 3B and 3C (and FIG. 4A) show a person blocking a signal path, detection of an MPE event generally only require determining transmissions with certain parameters would exceed MPE constraints and does not require detection of a person.

FIGS. 4A and 4B illustrates example carrier aggregation (CA) and handover scenarios, in which MPE events may also occur. In such cases, MPE constraints need to be met for all the radios. e.g., for sub 6 GHz (3G, 4G, 5G, WiFi, and Bluetooth) and 5G NR mmWave (e.g., 28 GHz, 39 GHz, . . . ) and scenarios with simultaneous transmissions also need to meet MPE constraints. For example, in an inter-band CA scenario (e.g., 28 GHz+39 GHz or 28 GHz+60 GHz), the total MPE from the bands need to meet the MPE constraints.

In FIG. 4A, a clear path to cell 0 may mean no MPE event is detected for that cell. For cell 1 and cell 2, however, because of a blocked signal path, in order to successfully transmit on the uplink the UE may need to use transmission parameters that do not comply with one or more MPE constraints. Therefore, in FIG. 4A, an MPE event is detected for uplink transmissions for cell 1 and cell 2.

FIG. 4B illustrates an example handover scenario. While no MPE event is illustrated in this example, handover from one cell to another is one example of an action that may be taken in response to detecting (or to avoid) an MPE event. In some cases, such a handover may be based on MPE assistance information, as described herein.

Aspects of the present disclosure provide techniques that may configure a UE to be detect an MPE event and report MPE assistance information measurements that may help a gNB reduce the impact of the MPE event detected by the UE.

FIG. 5 illustrates example operations 500 that may be performed by a UE, in accordance with certain aspects of the present disclosure. For example, operations 500 may be performed by a UE 120 of FIG. 1 or FIG. 2.

Operations 500 begin, at 502, by detecting a potential maximum permissible exposure (MPE) event. At 504, the UE provides MPE assistance information to a network entity in response to the detection.

FIG. 6 illustrates example operations 600 that may be performed by a network entity (e.g., a gNB), in accordance with certain aspects of the present disclosure, and may be considered complementary to operations 500 of FIG. 5. For example, operations 600 may be performed by a gNB to configure a UE to detect MPE events and report MPE assistance information according to operations 500 of FIG. 5.

Operations 600 begin, at 602, by receiving, from a user equipment (UE), maximum permissible exposure (MPE) assistance information indicating the UE has detected an MPE event. At 604, the network entity uses the MPE assistance information to adjust uplink scheduling of the UE in an effort to reduce impact of the MPE event.

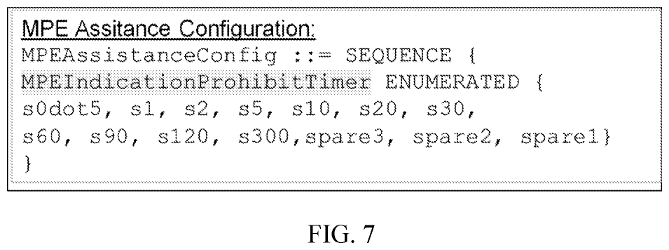

As described above, a UE may be configured to detect various MPE events and report MPE assistance information. For example, the MPE assistance information may be reported by the message of Radio resource control (RRC) information element (IE), which is named as MPEAssistance IE in RRC signaling. As illustrated in FIG. 7, in some cases, the configuration may include a timer designed to limit how often the UE reports the MPE assistance information. The value of the timer may be configured in an effort to conserve resources, while still providing relatively quick and efficient reporting.

Various types of information may be included in the MPE assistance information. In general, any type of information that may be used by the gNB to adjust uplink communications to reduce the impact of a detected MPE event may be included.

Examples of such information include one or more of: a preferred number of UL secondary cells (Scells), a preferred number of simultaneous UL Scells, a preferred total UL bandwidth, a preferred number of UL MIMO layers, and a preferred number of frequency-bands. The information may also include one or more preferred power related parameters, such as target received power (P0), pathloss compensation factor (alpha), and bits per resource element (BPRE). The information may also include one or more of a preferred minimum UL periodicity, a preferred multiplexing mode, a preferred number of simultaneous UL beams, and a preferred UL repetition interval.

Exactly what parameters are reported as MPE assistance information, as well as the particular values may depend on the particular event detected and objectives/preferences of the UE.

As an example, if the UE experiences an MPE event, if the UE prefers to temporarily reduce the number of maximum secondary component carriers for UL, the UE may:
include reducedMaxULCCs in the MPEAssistance IE;
set reducedULCCs to the number of maximum UL SCells the UE prefers to be temporarily configured in uplink; and
set suggestedCCstoReduce to the list of SCells with UL the UE prefers to be temporarily not configured in uplink.

If the UE prefers to temporarily reduce the number of simultaneous UL transmissions, the UE may:
include reducedMaxSimULs in the MPEAssistance IE; and
set reducedSimULs to the number of maximum simultaneous UL the UE prefers to be temporarily scheduled in uplink.

If the UE prefers to temporarily reduce maximum aggregated UL bandwidth, the UE may:
include reducedMaxULBW in the MPEAssistance IE;
set reducedULBW to the maximum aggregated bandwidth the UE prefers to be temporarily configured across all uplink carriers; and
set reducedMaxRBs to the maximum scheduled RBs the UE prefers to be temporarily scheduled in uplink carriers.

If the UE prefers to temporarily reduce the number of maximum UL MIMO layers of each serving cell:
include reducedMaxULMIMO-Layers in the MPEAssistance IE; and
set reducedULMIMO-Layers to the number of maximum MIMO layers of each
serving cell the UE prefers to be temporarily configured in uplink;

If the UE prefers to temporarily reduce the number of frequency bands, the UE may:
include reducedULfrequency-bands in the MPEAssistance IE; and
set reducedULfrequency-bandlist to the list of frequency bands the UE prefers to be temporarily configured with uplink.

If the UE prefers to temporarily reduce the P0, alpha and BPRE in power control, the UE may:
include reducedmaxP0AlphaandBPRE in the MPEAssistance IE; and
set reducedP0AlphaandBPRE to the maximum value of P0, alpha and BPRE the UE prefers to be temporarily configured with uplink.

If the UE prefers to temporarily increase the minimum periodicity of periodical or semi-periodical uplink Transmissions, the UE may:
include increaseMinPeriodicity in the MPEAssistance IE; and
set increasePeriodicity to the minimum of periodicity the UE prefers to be temporarily configured with uplink transmission.
   where the periodical or semi-periodical uplink transmission may include sounding reference signal (SRS), physical uplink shared channel (PUSCH), physical uplink control channel (PUCCH).

If the UE prefers to temporarily reduce the number of simultaneous uplink transmissions, the UE may:
include reducedMultiplexingMode in the MPEAssistance IE; and
set reducedMultiplexingMode to the nonFDM or nonSDM uplink schemes the UE prefers to be temporarily scheduled in uplink,
   where the nonFDM or nonSDM uplink scheme can be time division multiplexing (TDM) uplink transmission.

If the UE prefers to temporarily reduce the number of simultaneous uplink transmissions, the UE may:
include reducedMaxSimULBeams in the MPEAssistance IE; and
set reducedSimULBeams to the maximum of simultaneous uplink beams the UE prefers to be temporarily scheduled in uplink.

If the UE prefers to temporarily increase the interval of uplink repetition transmissions, the UE may:
include increasedRepetitionInterval in the MPEAssistance IE; and
set increasedMinRepetitionInterval to the minimum interval between the repetitions of uplink transmission the UE prefers to be temporarily scheduled in uplink.
   where the repetition of uplink transmission may include the repetition for SRS, PUSCH, PUCCH

As noted above, the UE may be configured to limit how often it reports the MPE Assistance information. For example, upon reporting MPE Assistance information, the UE may start a timer (e.g., the T346 timer) with the timer value set to the MPEIndicationProhibitTimer in the MPE Assistance configuration. Before the timer expires, the UE may not send another MPE Assistance information.

If and when the UE no longer experiences an MPE event, it may report in a manner that indicates no MPE event is currently detected (e.g., leaving out certain parameters). For example, to indicate the UE is no longer experiencing an MPE event, the UE may not include reducedMaxULCCs, reducedMaxSimULs, reducedMaxULBW, reducedMaxULMIMO-Layers, reducedULfrequency-bands, reducedmaxP0andBPRE, increaseMinPeriodicity, reducedMultiplexingMode, reducedMaxSimULBeams, or increasedMinRepetitionInterval in the MPEAssistance information element (IE). Even in this case, the UE may start a timer (e.g., timer T346) with the timer value set to the MPEIndicationProhibitTimer. Before the timer expires, the UE may not send another MPE Assistance information.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components. For example, various operations shown in FIGS. 5 and 6 may be performed by various processors shown in FIG. 2 of the BS 110 and/or UE 120.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIGS. 5 and 6.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by a user equipment (UE), comprising:
detecting a potential maximum permissible exposure (MPE) event; and
providing MPE assistance information to a network entity in response to the detection.

2. The method of claim 1, wherein the MPE assistance information comprises at least one of: a preferred number of uplink cells, a preferred number of simultaneous uplink secondary cells, a preferred total uplink bandwidth, or a preferred number of uplink MIMO layers.

3. The method of claim 1, wherein the MPE assistance information comprises at least one of: a preferred number of frequency-bands, preferred values for a set of parameters including P0, alpha, BPRE.

4. The method of claim 1, wherein the MPE assistance information comprises at least one of: a preferred minimum UL periodicity, a preferred Multiplexing Mode, a preferred number of simultaneous UL beams, or a preferred uplink repetition interval.

5. The method of claim 1, wherein, after detecting the MPE event, the UE includes a reduced preferred maximum secondary component carriers for UL in the MPE assistance information.

6. The method of claim 1, wherein the UE indicates it is no longer experience the MPE event by re-transmitting the MPE assistance information.

7. The method of claim 1, wherein, after detecting the MPE event, the UE includes a reduced number of simultaneous UL transmissions in the MPE Assistance information.

8. The method of claim 1, wherein, after detecting the MPE event, the UE includes a reduced maximum aggregated UL bandwidth in the MPE assistance information.

9. The method of claim 1, wherein, after detecting the MPE event, the UE includes at least one of a reduced maximum number of uplink multiple input multiple output (UL-MIMO) or a reduced number of frequency bands in the MPE assistance information.

10. The method of claim 1, wherein, after detecting the MPE event, the UE includes an increased minimum periodicity in the MPE assistance information.

11. The method of claim 1, wherein, after detecting the MPE event, the UE includes a reduced multiplexing mode.

12. The method of claim 1, wherein, after detecting the MPE event, the UE includes a reduced maximum number for simultaneously uplink or download.

13. The method of claim 1, wherein, after detecting the MPE event, the UE includes an increased repetition interval.

14. A method for wireless communications by a network entity, comprising:
receiving, from a user equipment (UE), maximum permissible exposure (MPE) assistance information indicating the UE has detected an MPE event; and
using the MPE assistance information to adjust uplink scheduling of the UE in an effort to reduce impact of the MPE event.

15. The method of claim 14, wherein the MPE assistance information comprises at least one of: a preferred number of uplink cells, a preferred number of simultaneous uplink secondary cells, a preferred total uplink bandwidth, or a preferred number of uplink MIMO layers.

16. The method of claim 14, wherein the MPE assistance information comprises at least one of: a preferred number of frequency-bands, preferred values for a set of parameters including P0, alpha, BPRE.

17. The method of claim 14, wherein the MPE assistance information comprises at least one of: a preferred minimum UL periodicity, a preferred Multiplexing Mode, a preferred number of simultaneous UL beams, or a preferred uplink repetition interval.

18. The method of claim 14, wherein, after detecting the MPE event, the UE includes a reduced preferred maximum secondary component carriers for UL in the MPE assistance information.

19. The method of claim 14, wherein the UE indicates it is no longer experience the MPE event by re-transmitting the MPE assistance information.

20. The method of claim 14, wherein, after detecting the MPE event, the UE includes a reduced number of simultaneous UL transmissions in the MPE Assistance information.

21. The method of claim 14, wherein, after detecting the MPE event, the UE includes a reduced maximum aggregated UL bandwidth in the MPE assistance information.

22. The method of claim 14, wherein, after detecting the MPE event, the UE includes at least one of a reduced maximum number of uplink multiple input multiple output (UL-MIMO) or a reduced number of frequency bands in the MPE assistance information.

23. The method of claim 14, wherein, after detecting the MPE event, the UE includes an increased minimum periodicity in the MPE assistance information.

24. The method of claim 14, wherein, after detecting the MPE event, the UE includes a reduced multiplexing mode in the MPE assistance information.

25. The method of claim 14, wherein, after detecting the MPE event, the UE includes a reduced maximum number for simultaneously uplink or download in the MPE assistance information.

26. The method of claim 14, wherein, after detecting the MPE event, the UE includes an increased repetition interval in the MPE assistance information.

27. An apparatus for wireless communications by a user equipment (UE), comprising:
means for detecting a potential maximum permissible exposure (MPE) event; and
means for providing MPE assistance information to a network entity in response to the detection.

28. An apparatus for wireless communications by a network entity, comprising:
means for receiving, from a user equipment (UE), maximum permissible exposure (MPE) assistance information indicating the UE has detected an MPE event; and
means for using the MPE assistance information to adjust uplink scheduling of the UE in an effort to reduce impact of the MPE event.

29. An apparatus for wireless communications by a user equipment (UE), comprising:
at least one processor configured to detect a potential maximum permissible exposure (MPE) event; and
a transmitter configured to provide MPE assistance information to a network entity in response to the detection.

30. An apparatus for wireless communications by a network entity, comprising:
a receiver configured to receive, from a user equipment (UE), maximum permissible exposure (MPE) assistance information indicating the UE has detected an MPE event; and
at least one processor configured to use the MPE assistance information to adjust uplink scheduling of the UE in an effort to reduce impact of the MPE event.
